(19) United States
(12) Patent Application Publication
(10) Pub. No.: US 2024/0369803 A1
(43) Pub. Date: Nov. 7, 2024

(54) LENS APPARATUS AND IMAGE PICKUP APPARATUS

(71) Applicant: CANON KABUSHIKI KAISHA, Tokyo (JP)

(72) Inventor: Makoto HAYAKAWA, Tochigi (JP)

(21) Appl. No.: 18/640,034

(22) Filed: Apr. 19, 2024

(30) Foreign Application Priority Data
May 1, 2023 (JP) 2023-075692

(51) Int. Cl. G02B 7/02

(52) U.S. Cl. CPC G02B 7/026

(57) ABSTRACT

Provided is a lens apparatus including: an optical member; a holding barrel holding the optical member, and a rotation restriction member fixed to the optical member, wherein the rotation restriction member is configured to come into abutment against the holding barrel along a direction of rotation of the optical member about an optical axis, to restrict the rotation of the optical member about the optical axis, relative to the holding barrel, and lacks contact with the holding barrel along an optical-axis direction and a radial direction of the optical member.

### BACKGROUND OF THE INVENTION

### Field of the Invention

The present invention relates to a lens apparatus and an image pickup apparatus.

### Description of the Related Art

For some lens barrels of interchangeable lenses or the like, thermal caulking or an adhesive is used for fixing a lens to a lens holding barrel. In this configuration, due to stress generated during fixing of the lens, a change in surface accuracy of a lens surface (distortion of the lens surface) is caused, resulting in degradation of lens performance in some cases. In Japanese Patent Application Laid-Open No. 2016-109804, there is disclosed a technology of fixing a lens via an elastic member in order to reduce distortion of the lens surface.

In Japanese Patent Application Laid-Open No. 2016-109804, there is described a pressing member that is fixed to a lens holder, and, by intervention of the pressing member formed of a ring-shaped elastically-deformable elastic material, such as a foam material or rubber, a lens is fixed while being pressed against the lens holder. In order to reduce distortion of the lens surface caused due to stress for fixing the lens, it is required to fix a lens with a weak force. In a specific example, in a case in which the mass of a lens is approximately 10 g, with a force of approximately 500 mN, stress acting on the lens is low with respect to lens stiffness, and hence, distortion of the lens surface can be reduced.

However, in a case in which a lens is fixed via an elastic member provided in a narrow slit between the pressing member and the lens, a spring constant of the elastic member is extremely high, resulting in an extremely high pressing force. Further, it is difficult to stably press each individual lens with the same force.

Moreover, in a case in which the method for fixing a lens according to Japanese Patent Application Laid-Open No. 2016-109804 is applied to a lens placed closest to an object, the lens is rotated about an optical axis when a force of rotation about the optical axis is externally applied to the lens, which causes a risk of changing the optical performance.

### SUMMARY OF THE INVENTION

It is an object of the present invention to provide a lens apparatus that can suppress rotation of a lens about an optical axis while reducing distortion of a lens surface.

In order to achieve the above-mentioned object, according to the present invention, there is provided a lens apparatus including: an optical member; a holding barrel holding the optical member; and a rotation restriction member fixed to the optical member, wherein the rotation restriction member is configured to come into abutment against the holding barrel along a direction of rotation of the optical member about an optical axis, to restrict the rotation of the optical member about the optical axis, relative to the holding barrel, and lacks contact with the holding barrel along an optical-axis direction and a radial direction of the optical member.

According to the present invention, the lens apparatus that can suppress rotation of the lens about the optical axis while reducing distortion of the lens surface can be provided.

Further features of the present invention will become apparent from the following description of exemplary embodiments with reference to the attached drawings.

### BRIEF DESCRIPTION OF THE DRAWINGS

FIG. 1 is a view for illustrating a configuration of a lens barrel and a camera according to a first embodiment.

FIG. 2A is a front view for illustrating a configuration of a first unit barrel according to the first embodiment.

FIG. 2B is a side view for illustrating a configuration of the first unit barrel according to the first embodiment.

FIG. 2C is a sectional view for illustrating a configuration of the first unit barrel according to the first embodiment.

FIG. 3 is a sectional view taken along the line B-B in FIG. 2B according to the first embodiment.

FIG. 4 is a sectional view taken along the line C-C in FIG. 2A according to the first embodiment.

FIG. 5 is a sectional view of an interchangeable lens according to the first embodiment.

FIG. 6 is a sectional view of an interchangeable lens according to a second embodiment.

FIG. 7 is a perspective view of a first unit barrel according to the second embodiment.

### DESCRIPTION OF THE EMBODIMENTS

Now, exemplary embodiments of the present invention are described in detail based on the attached drawings.

### First Embodiment

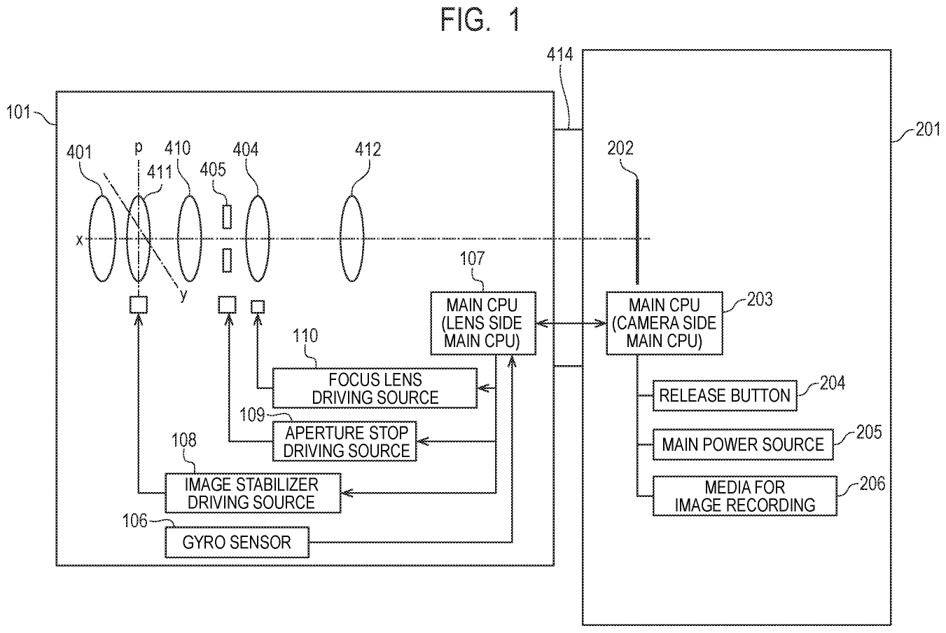

With reference to FIG. 1, a system configuration of an image pickup apparatus including a lens apparatus 101 of the present invention and a camera apparatus 201 that picks up an image formed by the lens apparatus 101 is described.

FIG. 1 is a view for illustrating a configuration of the lens apparatus 101 and the camera apparatus 201 according to a first embodiment of the present invention. The lens apparatus 101 includes a first unit barrel 401, an image stabilizer unit 411, a rear unit barrel 410, an aperture stop unit 405, a focus barrel 404, and a fifth unit barrel 412, and each barrel holds a lens unit.

Further, a gyro sensor 106 serving as a camera-shake detection unit and a lens side main CPU 107 that performs drive control and calculation for the entire lens are included. The lens side main CPU 107 outputs drive commands to an aperture stop driving source 109 and a focus lens driving source 110, and the aperture stop unit 405 and the focus barrel 404 are driven by the respective drive commands.

An image stabilizer includes the image stabilizer unit 411 and an image stabilizer driving source 108. For image stabilization control, the lens side main CPU 107 calculates an amount of stabilization based on a detection value of the gyro sensor 106, and outputs a drive command to the image stabilizer driving source 108. As a result of this, the image stabilizer unit 411 is driven in a “y” direction (yaw direction) and a “p” direction (pitch direction) that are orthogonal to an optical axis “x” and are orthogonal to each other, and thus image stabilization is performed.

The lens side main CPU 107 can determine how the lens apparatus 101 and the camera apparatus 201 are held (the postures) based on a detection value of the gyro sensor 106. The lens apparatus 101 is removably fixed to the camera apparatus 201 via a mount 414, and can pick up an image of an object formed on an image pickup element 202 of the camera apparatus 201, with the use of an optical system of the lens apparatus 101.

The camera apparatus 201 includes a camera side main CPU 203, a release button 204 serving as an operating member, a main power source 205, a media for image recording 206, and the like. The release button 204 has a two-stage press mechanism that can be pressed to two depth stages depending on the pressing depth of the button. A press to the first stage is referred to as a half press of shutter, and a press to the second stage is referred to as a full press of shutter. By a half press of shutter, commands for making preparations for starting shooting, such as returning from shooting standby, starting image stabilization, starting an autofocus operation, starting photometry, and the like, are output. By a full press of shutter, a command for shooting and recording an image onto the media for image recording 206 is output.

Further, via a contact block (not shown) provided in the mount 414, power is supplied from the camera apparatus 201 to the lens apparatus 101, and communication of shooting information or the like between the camera side main CPU 203 and the lens side main CPU 107 is performed.

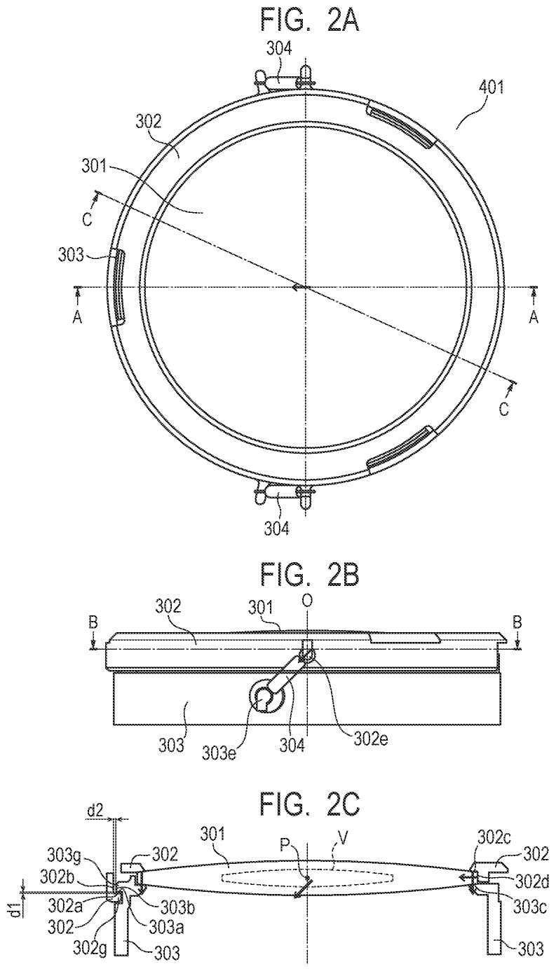

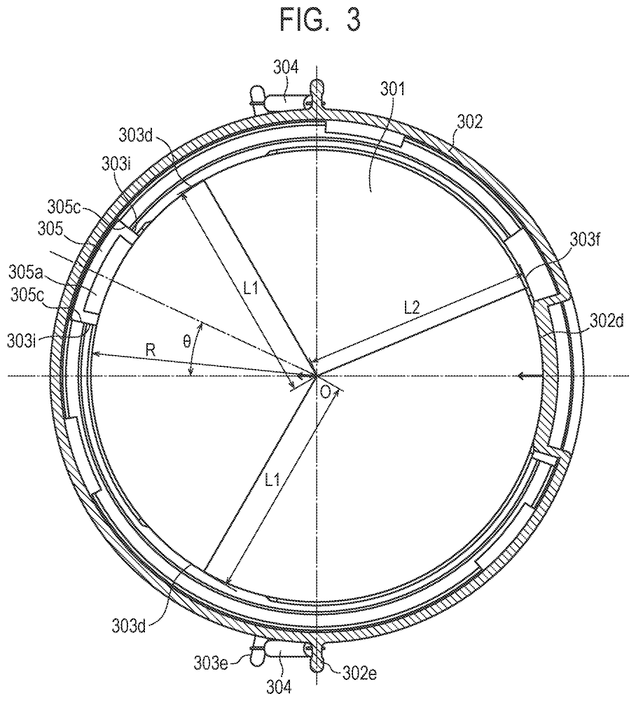

FIG. 2A, FIG. 2B, FIG. 2C, and FIG. 3 are views for illustrating a configuration of the first unit barrel 401 of the lens apparatus 101 according to the present invention. With reference to FIG. 2A, FIG. 2B, FIG. 2C, and FIG. 3, a method for holding a lens according to the present invention is described. FIG. 2A, FIG. 2B, and FIG. 2C are views for illustrating the configuration of the first unit barrel 401. FIG. 2A is a plan view seen from an object side along an optical-axis direction. FIG. 2B is a side view seen from a lower side of the drawing sheet of FIG. 2A. FIG. 2C is a sectional view taken along the line A-A in FIG. 2A. FIG. 3 is a sectional view taken along the line B-B in FIG. 2B.

The first unit barrel 401 includes a lens (optical member) 301, a biasing barrel 302, a holding barrel 303, and elastic members 304. The lens 301 is held in the holding barrel 303. For the elastic member (biasing member) 304, a tension coil spring is used in the first embodiment, but the elastic member 304 may be formed of a flat spring of a compression coil spring, rubber, or the like. The elastic member 304 includes a first hook and a second hook. The first hook is provided at one end of the elastic member 304 and is engaged with an elastic-member fixing part 302e of the biasing barrel 302. The second hook is provided at another end of the elastic member 304 and is engaged with an elastic-member fixing part 303e of the holding barrel 303. The two elastic members 304 are formed of two tension coil springs placed at positions substantially opposite to each other across an optical axis O, and are each placed at an angle of approximately 45 degrees with respect to a plane perpendicular to the optical axis O. In FIG. 2B, the biasing barrel 302 is biased obliquely toward lower left of the drawing sheet. That is, the biasing barrel 302 presses the lens 301 against the holding barrel 303 along the optical-axis direction while pressing the lens 301 toward one side (a left side in FIG. 2B) in the plane perpendicular to the optical axis.

With this arrangement, a resultant force of tensile forces of the two tension coil springs acts in a direction inclined at an angle of approximately 45 degrees with respect to the plane perpendicular to the optical axis O. Here, approximately 45 degrees with respect to the plane perpendicular to the optical axis may be 30 degrees or larger and 60 degrees or smaller, preferably 40 degrees or larger and 50 degrees or smaller, and more preferably 42 degrees or larger and 48 degrees or smaller, with respect to the plane perpendicular to the optical axis.

The lens 301 is placed so as to be sandwiched between the holding barrel 303 and the biasing barrel 302. The lens 301 is biased in the optical-axis direction and a direction orthogonal to the optical axis by the elastic members 304 via the biasing barrel 302, to thereby be positioned and fixed to the holding barrel 303. The holding barrel 303 includes optical axis direction receiving parts 303c at three spots at intervals of approximately 120° along a circumferential direction, to position the lens 301 along the optical-axis direction. Alternatively, the optical axis direction receiving parts 303c may be formed at three or more spots, or may be formed along an entire circumference.

The biasing barrel 302 includes optical-axis-direction biasing parts 302c at three spots in contact with the lens 301, at intervals of approximately 120° along the circumferential direction. The optical-axis-direction biasing parts 302c may be formed at three or more spots, or may be formed along an entire circumference.

The elastic members 304 are formed of two tension coil springs placed at positions substantially opposite to each other across the optical axis O, and thus, a resultant force of biasing forces of the elastic members 304 acts on the vicinity of the optical axis. This allows the biasing barrel 302 to bias the vicinity of the center of gravity of the lens 301 toward the holding barrel 303 along the optical-axis direction, so that the lens 301 can be biased in good balance, to be stably positioned. In a case in which a position far from the center of gravity of the lens 301 is biased, the axis of the lens 301 is liable to tilt with respect to the optical axis due to possible application of an external force or the like, causing a risk of degrading the optical performance of the entire lens.

The holding barrel 303 includes two optical-axis orthogonal direction receiving parts 303d for positioning of the lens 301 in the plane perpendicular to the optical axis, at two spots. The biasing barrel 302 is biased toward a left side of the drawing sheet of FIG. 3 by biasing forces that are applied by the two tension coil springs and include components in the plane perpendicular to the optical axis. The optical-axis orthogonal direction receiving parts 303d placed at two spots in the holding barrel 303 are placed on a side opposite to the side where the two elastic-member fixing parts 302e of the biasing barrel 302 are placed, with respect to a first plane parallel to the optical axis passing through the two elastic-member fixing parts 303e. Further, the optical-axis orthogonal direction receiving parts 303d placed at two spots are placed at positions symmetric with respect to a second plane that is perpendicular to the first plane and includes the optical axis, and are placed at positions approximately 120° apart from each other with the optical axis at the center therebetween.

Further, in the first embodiment, the optical-axis orthogonal direction receiving parts 303d are each formed in an arc shape that is centered at the optical axis and has a radius L1 in the plane perpendicular to the optical axis. However, the optical-axis orthogonal direction receiving part 303d is not limited to an arc shape in the plane perpendicular to the optical axis, and may be formed, for example, as a notched part in a D-cut shape.

A cylindrical outer peripheral surface forming an outer peripheral surface of the lens 301 and having an axis parallel to the optical axis has a radius R. In the first embodiment, the optical-axis orthogonal direction receiving part 303d is formed in an arc shape centered at the optical axis, and a distance (radius) thereof from the optical axis is set to L1. The optical-axis orthogonal direction receiving part 303d may be formed of a flat surface, and, in such a case, a minimum distance between the flat surface and the optical axis is set to L1. In the holding barrel 303, a supplementary fitting part (guide part) 303f is provided on a side opposite to the optical-axis orthogonal direction receiving part 303d with respect to the first plane. The supplementary fitting part 303f is used to temporarily assemble the lens 301 and the holding barrel 303 for rough positioning thereof before the biasing barrel 302 is incorporated. The supplementary fitting part 303f is formed in an arc shape having a distance (radius) L2 from the optical axis, and a phase into which an optical-axis orthogonal-direction biasing part 302d described later is inserted is cut out.

The optical-axis orthogonal-direction biasing part 302d biases the lens 301 toward the left side of the drawing sheet of FIG. 3 in the plane perpendicular to the optical axis with the use of biasing forces of the elastic members 304, to position the lens 301 to the holding barrel 303 in the plane perpendicular to the optical axis.

Here, among the radius L1 of the optical-axis orthogonal direction receiving part 303d centered at the optical axis, the radius L2 of the supplementary fitting part 303f centered at the optical axis, and the radius R of the outer shape of the lens 301, the following relationships are satisfied.

L1=R (1)

R<L2 (2)

First, because of the relationship of L1=R, the lens 301 is held while being pressed by the optical-axis orthogonal direction receiving parts 303d of the holding barrel 303, and hence the lens 301 can be accurately fixed at a design position in the holding barrel 303 without decentration. This can suppress degradation of the optical performance of an entire lens apparatus. Further, L2−L1, that is, a difference between L2 and L1, is set to a minimum value. It is only required to set the amount of difference such that the lens 301 is not press-fitted in the holding barrel 303, but is held so as to have some play in the plane perpendicular to the optical axis when the lens 301 is temporarily fixed to the holding barrel 303. It is only required that L2 be set to a value larger than L1 even by the slightest difference, for example, 0.01 mm.

In the first embodiment, a case in which the supplementary fitting part 303f is formed in an arc shape that is centered at the optical axis and has the radius L2 has been discussed, but the present invention is not limited to this configuration. It is only required that the guide part 303f in which a position at a distance of the radius R or larger from the optical axis is a position located the closest to the optical-axis orthogonal direction receiving part 303d be provided on the side opposite to the optical-axis orthogonal direction receiving part 303d with respect to the first plane.

Thus, when the lens 301 is temporarily held in the holding barrel 303, the lens 301 is not press-fitted, and no stress is applied to the lens 301, which prevents occurrence of distortion of the lens surface due to temporary holding.

Further, while the lens 301 is temporarily held in the holding barrel 303, the lens 301 is held at a position close to that at the time of completion of assembly in which the biasing barrel 302 is incorporated. This facilitates subsequent assembly. When impact is applied to the lens 301 in the direction orthogonal to the optical axis after completion of assembly, and a force of impact to move the lens 301 in a direction opposite to a biasing force of the elastic member 304 is applied, the biasing barrel 302 is displaced. However, when the biasing barrel 302 is displaced, the optical-axis orthogonal direction receiving parts 303d function as rear stoppers, to thereby prevent the lens 301 from largely deviating.

As indicated by an arrow in FIG. 2B, the biasing barrel 302 is biased toward the lower left of the drawing sheet with respect to the optical axis by a biasing force of the elastic member 304. As a result of this, positioning of the lens 301 along the optical-axis direction and in the plane perpendicular to the optical axis is achieved with only one biasing barrel 302.

For positioning of the lens 301 along the optical-axis direction, the lens 301 is pressed against the optical axis direction receiving parts 303c of the holding barrel 303 by the biasing barrel 302, to be positioned. To accurately form the surfaces of the optical axis direction receiving parts 303c enables accurate positioning of the lens 301 along the optical-axis direction, to thereby prevent the lens surface from tilting. At that time, a biasing force of the elastic member 304 in the optical-axis direction is set to a force of approximately two to ten times the mass of the lens 301. More specifically, in a case in which the mass of the lens 301 is 10 g, a biasing force in the optical-axis direction is set to approximately 200 to 1,000 mN. This is a value smaller than stress that is applied to the lens, for example, in a case in which the lens is fixed to a barrel by thermal caulking. To press the lens with such a weak force as described can reduce distortion of the lens surface, to thereby suppress degradation of the optical performance of the entire lens apparatus.

For positioning of the lens 301 in the plane perpendicular to the optical axis, the lens 301 is positioned while being pressed against the optical-axis orthogonal direction receiving parts 303d of the holding barrel 303 by the biasing barrel 302. As described above, the distance L1 of the optical-axis orthogonal direction receiving part 303d from the optical axis and the radius R of the lens 301 are set so as to satisfy L1=R. This allows the lens 301 to be accurately positioned with respect to the design position in the holding barrel 303 without decentration. At that time, a biasing force of the elastic member 304 in the direction orthogonal to the optical axis is set to a force of approximately two to ten times the mass of the lens 301. More specifically, in a case in which the mass of the lens 301 is 10 g, a biasing force in the direction orthogonal to the optical axis is set to approximately 200 to 1,000 mN. This is a value much smaller than stress that is radially applied to the lens 301, for example, in a case in which the lens 301 is press-fitted and fixed to the holding barrel 303 under a radial compression force. In a case in which the lens 301 is biased with a force of approximately two to ten times the mass of the lens 301 as in the present invention, the value of distortion of the lens surface can be reduced, and, consequently, degradation of the optical performance of the entire lens apparatus can be suppressed.

In the first embodiment, a tension coil spring is used as the elastic member 304. To use a wave washer as the elastic member 304 would make it difficult to secure a space long enough to place the elastic member 304 along a biasing direction, making it difficult to reduce a spring constant. Hence, a slight change in a spacing results in a significant change in a biasing force, making it difficult to correctly apply a design biasing force. In a case in which a design biasing force has a relatively small value of approximately 200 to 1,000 mN as described above, it is more difficult to apply a design biasing force. Also in a case in which a resin spring or rubber is used as the elastic member 304, the spring constant is increased, making it difficult to apply a design biasing force. Further, when a creep phenomenon occurs due to rise in temperature, there is a risk of changing a biasing force with time.

In a case in which a tension spring is used as the elastic member 304, only with a sufficient spring length, the spring constant can be set to a small value, making it easy to achieve a weak biasing force as designed. Further, a biasing force is unlikely to be changed with time. Thus, in the first embodiment in which a tension spring is used as the elastic member 304, both of a weak biasing force as designed and space saving for placement can be achieved. For the elastic member 304, not only a tension spring, but also a flat spring or the like, can be used as long as the above-described requirement is satisfied.

Further, in order to stably bias and fix the lens 301 with accuracy as described above, it is preferred that a resultant force of elastic forces of the elastic members 304 act on the vicinity of a center of gravity P of the lens 301 as illustrated in FIG. 2C. An area V illustrated in FIG. 2C is an area equal to or smaller than a half of an area extending from the center of gravity P of the lens 301 to the outer edge of the lens 301. When a resultant force of biasing forces of the elastic members 304 acts on the inside of the area V, the lens 301 can be stably positioned and fixed along the optical-axis direction and the direction orthogonal to the optical axis. On the other hand, when a resultant force of biasing forces of the elastic members 304 acts on a position outside of the area V, biasing forces received by the optical axis direction receiving parts 303c vary with each position, and hence the lens 301 is insufficiently pressed in a phase around the optical axis where the biasing force is weak, so that the lens may possibly tilt. Moreover, when a resultant force of biasing forces of the elastic members 304 acts on a position far off the area V, it turns into the moment that can cause the lens 301 to tilt, possibly inducing lens tilt.

In the first embodiment, the tension coil springs serving as the elastic members 304 are placed at two positions opposite to each other across the vicinity of the center of gravity P of the lens 301 in order that a resultant force of biasing forces of the elastic members 304 can act on the inside of the area V in the lens 301. Further, as illustrated in FIG. 2B, the two tension coil springs bias the biasing barrel 302 in the same direction, obliquely with respect to the optical axis. This configuration allows a resultant force of biasing forces of the elastic members 304 to act on the inside of the area V, with a small number of springs and a small space. However, the elastic member 304 is not limited to this configuration, and three or more elastic members may be used as long as a resultant force of biasing forces of the elastic members 304 can act on the inside of the area V in the vicinity of the center of gravity P of the lens 301.

Next, assembly of the present unit is described. First, the lens 301 is placed while being aligned such that the outer peripheral surface of the lens 301 faces the optical-axis orthogonal direction receiving parts 303d and the supplementary fitting parts 303f of the holding barrel 303. The lens 301 is not fixed by press-fitting in a radial direction, and hence a special tool is not required.

Subsequently, the biasing barrel 302 is incorporated into the holding barrel 303. The biasing barrel 302 includes bayonet claws 302g at three spots at intervals of 120°. The holding barrel 303 includes bayonet grooves 303g at three spots corresponding to the bayonet claws 302g at intervals of 120°. The biasing barrel 302 includes a mounting groove at a position rotated approximately 15° about the optical axis, relative to the holding barrel 303, with respect to a position mounted in the holding barrel 303, and, in this phase, the biasing barrel 302 is inserted to a predetermined optical-axis-direction position. Then, the biasing barrel 302 is rotated 15°, to thereby be incorporated into a position at completion illustrated in FIG. 2C. This is similar to a typical bayonet-type configuration/assembly.

Under the above-described state, the two hooks of the tension coil springs serving as the elastic members 304 are caused to catch the elastic-member fixing part 302e and the elastic-member fixing part 303e, and thus the tension coil springs are fixed. Consequently, the biasing barrel 302 is positioned regarding both of the position relative to the holding barrel 303 along the optical-axis direction and the phase in the direction of rotation, under tensile forces of the elastic members 304.

As described above, for assembly, a unit in which the lens 301 is fixed to the holding barrel 303 can be formed easily without a need of a special tool such as a tool used for thermal caulking of a lens, and hence assembly is easy.

Next, behaviors in a case in which impact is applied to the lens 301 are described.

The biasing barrel 302 includes an optical-axis orthogonal-direction stopper 302b in a phase on a side opposite to the optical-axis-direction biasing part 302c of the biasing barrel 302 along the direction orthogonal to the optical axis while the biasing barrel 302 is mounted in the holding barrel 303. As illustrated in FIG. 2C, the optical-axis orthogonal-direction stopper 302b and an optical-axis orthogonal-direction stopper 303b of the holding barrel 303 are arranged so as to have an optical-axis orthogonal-direction gap d2 therebetween. It is preferred to minimize the optical-axis orthogonal-direction gap d2 within a range in which the gap does not vanish even when manufacturing variation of parts is taken into account. An optical-axis-direction stopper 303a of the bayonet groove 303g of the holding barrel 303 and an optical-axis-direction stopper 302a of the bayonet claw 302g of the biasing barrel 302 are arranged so as to have an optical-axis-direction gap d1 therebetween along the optical-axis direction. It is preferred to minimize the optical-axis-direction gap d1 within a range in which the gap does not vanish even when manufacturing variation of parts is taken into account.

Because of the above-described bayonet mechanism, while the lens 301 is held, there are positional plays of the biasing barrel 302 and the holding barrel 303 relative to each other along the optical-axis direction and the direction orthogonal to the optical axis, and a travel-amount limiting part that limits an amount of relative travel is formed.

In a case in which a force equal to or greater than a biasing force of the elastic member 304 is applied to the biasing barrel 302 in a direction opposite to the direction of the biasing force due to application of impact caused by drop or the like, the biasing barrel 302 travels in the direction opposite to the direction of the biasing force, and also the lens 301 similarly travels in the same direction. However, along the direction orthogonal to the optical axis, the optical-axis orthogonal-direction stopper 302b and the optical-axis orthogonal-direction stopper 303b function as stoppers, to prevent the biasing barrel 302 and the lens 301 from travelling a distance longer than the optical-axis orthogonal-direction gap d2. When the force of impact is eliminated, the biasing barrel 302 and the lens 301 are returned to the positions where they have been originally positioned, by a biasing force of the elastic member 304.

Along the optical-axis direction, the optical-axis-direction stopper 303a and the optical-axis-direction stopper 302a function as stoppers, to prevent the biasing barrel 302 and the lens 301 from travelling a distance longer than the optical-axis-direction gap d1. When the force of impact is eliminated, the biasing barrel 302 and the lens 301 are returned to the positions where they have been originally positioned, by a biasing force of the elastic member 304.

In this regard, the larger the optical-axis orthogonal-direction gap d2 and the optical-axis-direction gap d1 are, the larger the movable ranges of the biasing barrel 302 and the lens 301 are, but, in the first embodiment, the movable ranges are small because the optical-axis orthogonal-direction gap d2 and the optical-axis-direction gap d1 are set to small values. This can reduce a risk that stress may be generated under a torsional state due to tilt of the lens 301 and that the lens 301 may stop before reaching the positioning position due to friction between the lens 301 and the biasing barrel 302 and friction between the lens 301 and the holding barrel 303. Thus, despite application of impact, after the impact, the lens 301 and the biasing barrel 302 can be returned to the positions where they have been originally positioned, with no change in the relative positions of the lens 301 and the holding barrel 303. That is, a lens that is less changed in the optical performance despite application of impact can be achieved.

As described above, the configuration according to the present invention enables reduction of distortion of the lens surface and highly-accurate positioning of the lens, to thereby provide a lens apparatus that can be maintained without degradation of the optical performance. In this regard, in order to make the total length and the total weight of the lens apparatus smaller, it is preferred to minimize the thickness of the center and the thickness of a peripheral portion in the lens. However, to reduce the thickness of the lens would reduce the stiffness of the lens, and thus distortion of the lens surface is more liable to occur. Even in such a situation, to apply the configuration of the present invention enables reduction of distortion of the lens surface, and hence a lens apparatus that can be maintained without degradation of the optical performance can be achieved. Further, also even in a case in which distortion of the lens surface occurs, degradation of the optical performance can be canceled in a situation in which similar distortion of the lens surface occurs in each of a front surface and a rear surface of the lens. On the other hand, in a case in which a mirror lens (reflection optical element) typified by a telescope or the like is used, there is no correlation for cancellation as described above, and thus, surface distortion of a mirror lens directly leads to degradation of the optical performance. The configuration of the present invention does not rely on cancellation of distortion that occurs in the optical surface in order to prevent degradation of the optical performance, but can reduce distortion itself of the optical surface to smaller, and thus can be effectively applied also to a holding structure for a mirror lens.

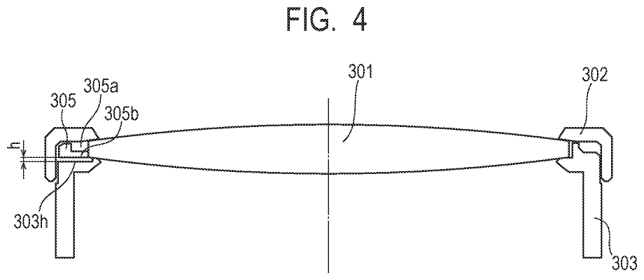

Next, a configuration for suppressing rotation of the lens 301 about the optical axis is described with reference to FIG. 3 and FIG. 4.

An anti-rotation member 305 (rotation restriction member) is formed of fiberglass-reinforced polycarbonate resin. Like this, the other barrels in the first embodiment, for example, the holding barrel 303 and the biasing barrel 302 are also formed of fiberglass-reinforced polycarbonate resin, that is, the same material as that of the anti-rotation member 305. However, the anti-rotation member 305 is not limited to that, and may be formed of other plastic or metal.

In the anti-rotation member 305, there is formed an adhesion groove 305a to which an adhesive for bonding the lens 301 and the anti-rotation member 305 to each other is supplied. For the adhesive, an ultraviolet curing adhesive is used in the first embodiment, but the adhesive is not limited thereto, and other adhesives such as a thermosetting adhesive and a moisture curing adhesive may be used.

The anti-rotation member 305 is engaged with a recess (a notched part provided in a part along the circumferential direction) of the holding barrel 303, and an positioning part 305c of the anti-rotation member 305 comes into abutment against an positioning part 303i of the holding barrel 303, to thereby restrict rotation of the lens 301 and the holding barrel 303 about the optical axis.

As illustrated in FIG. 3, in the plane perpendicular to the optical axis, the center between the positioning part 305c and the positioning part 303i forms an angle θ with the biasing direction. It is preferred to set the angle θ to a small value in order that the positioning part 305c and the positioning part 303i may not hinder positioning of the lens 301 along the direction orthogonal to the optical axis, which should be defined by abutment between the lens 301 and the optical-axis orthogonal direction receiving parts 303d. Specifically, it is preferred to set the angle θ to 30 degrees or smaller.

As illustrated in FIG. 4, there is a clearance “h” between a bottom surface 305b of the anti-rotation member 305 and a surface 303h of the holding barrel 303. The presence of the clearance “h” prevents the anti-rotation member 305 from affecting definition of the position of the lens 301 along the optical-axis direction and the position of lens tilt. This enables highly-accurate positioning of the lens 301. There may possibly be caused a slight change in the relative positions of the lens 301 and the anti-rotation member 305 due to heat shrinkage or change with time of the adhesive, but the presence of the clearance “h” prevents the anti-rotation member 305 from affecting positioning of the lens despite such a change as described above. Thus, high reliability of the lens 301 can be maintained.

A method for bonding the lens 301 and the anti-rotation member 305 while securing the clearance “h” is described. The lens 301 and the anti-rotation member 305 are bonded while being positioned so as to have the positional relationship illustrated in FIG. 4, by a jig and a tool. Thus, the lens 301 and the anti-rotation member 305 can be bonded and fixed at the corresponding positions. Alternatively, another possible way to achieve the adhesion is to interpose a spacer corresponding to the clearance “h” while temporarily placing the lens 301 in the holding barrel 303, bond and fix the adhesion groove 305a, and then remove the spacer.

The anti-rotation member 305 is formed so as to have a clearance also between the anti-rotation member 305 and the biasing barrel 302 along the optical-axis direction and the direction orthogonal to the optical axis.

With the above-described configuration, the anti-rotation member 305 affects nothing but positioning of the lens 301 and the holding barrel 303 in the direction of rotation, and does not affect positioning of the lens 301 along the optical-axis direction and the direction orthogonal to the optical axis.

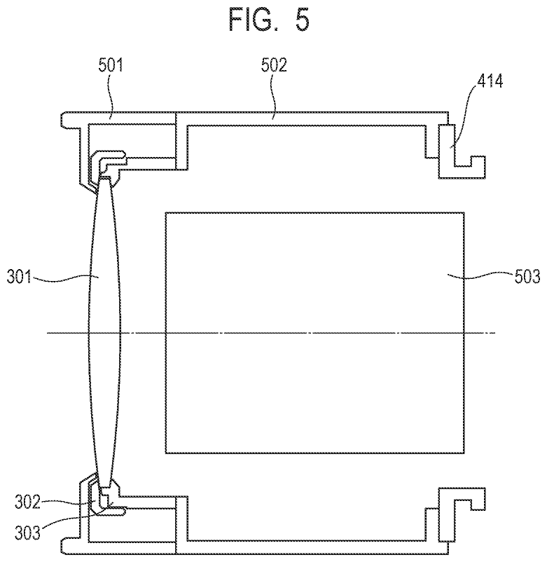

FIG. 5 is a schematic sectional view of the lens apparatus to which the lens holding structure according to the first embodiment is applied. The mount 414, a filter frame 501, and the holding barrel 303 are fixed to a fixing barrel 502 by screwing or the like. Lens elements irrelevant to description of the lens holding structure according to the first embodiment are illustrated as a lens element 503.

The lens 301 is a lens located closest to an object, and thus a user can touch the lens from an outside. As described above, the lens 301 is biased and fixed by a weak force of the elastic member 304 in order to reduce distortion of the lens surface of the lens 301. For example, even when a force in the direction orthogonal to the optical axis is applied to the lens 301, and the lens 301 is off the center within the play thereof, the lens 301 can be returned to the position where it has been originally positioned, by an elastic force of the elastic member 304.

In a case in which a force of rotation about the optical axis is applied to the lens 301 without the anti-rotation member 305, the lens 301 rotates, resulting in a change in the optical performance. In the configuration according to the first embodiment, the anti-rotation member 305 restricts relative rotation of the lens 301 and the holding barrel 303. Thus, despite application of a force of rotation about the optical axis, to the lens 301, the lens 301 is prevented from rotating, and thus the optical performance is not changed. Further, adhesion of the anti-rotation member 305 to the lens 301 as described above does not affect positioning other than positioning in the direction of rotation, and thus, does not cause reduction of the positioning accuracy of the lens 301 or reduction of the surface accuracy.

### Second Embodiment

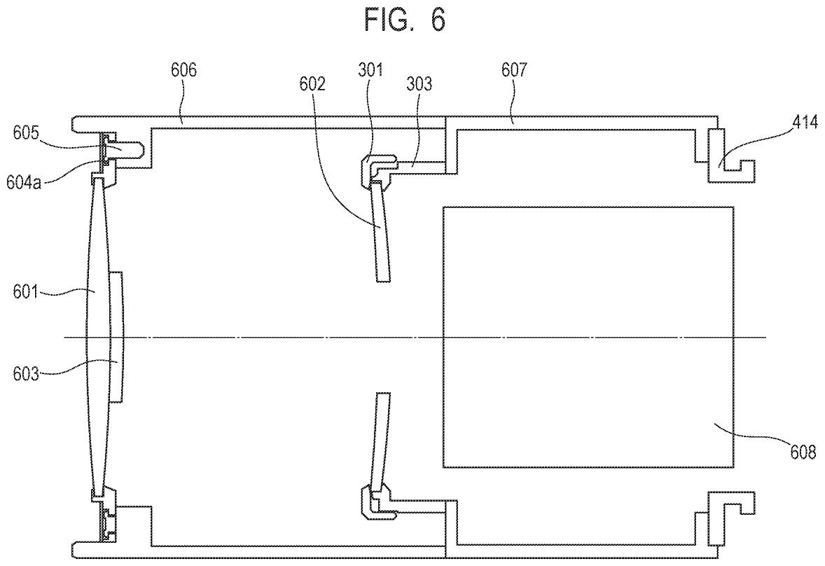

FIG. 6 is a sectional view of a lens apparatus according to a second embodiment. This optical system is a reflection optical system, and includes a first lens 601, a second lens (optical member) 602, and a third lens 603 that are sequentially arranged from the object side along an optical path. An optical surface on the image side (a right side in FIG. 6) in the second lens 602 is a reflection surface, and an optical surface on the image side in the third lens 603 is a reflection surface. Light incident from the object side passes through the first lens 601, enters into the second lens 602 through an object-side surface thereof, and is reflected from an image-side surface. After that, the light passes through the object-side surface of the second lens 602, is reflected from the image-side surface of the third lens 603, and passes through a lens element 608, to form an image on an image pickup surface.

A first unit barrel 604 is fixed to a front holding barrel 606 by three screws 605. The first lens 601 is fixed to the first unit barrel 604 by thermal caulking or the like. The third lens 603 is bonded to the image side of the first lens 601 with an adhesive, to be fixed. The front holding barrel 606, the mount 414, and the holding barrel 303 are fixed to a fixing barrel 607 by screws or the like. Regarding fixing of the second lens 602 to the holding barrel 303, a configuration thereof is similar to that described in the first embodiment except that the lens 301 is replaced with the second lens 602, and hence description thereof is omitted.

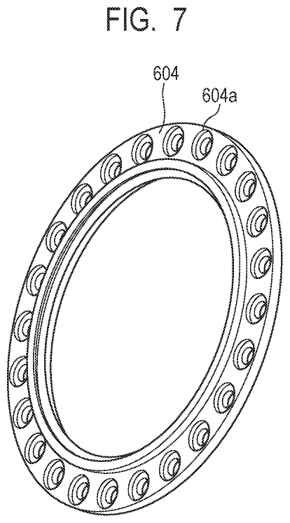

FIG. 7 is a perspective view of the first unit barrel 604 according to the second embodiment. The first unit barrel 604 includes screw seats 604a at 24 spots at substantially equal intervals of 15° along the circumferential direction. With this configuration, the first unit barrel 604 can be rotated with increments of 15 degrees, to be fixed to the front holding barrel 606 by the screws 605.

In the second lens 602, the image-side surface is a reflection surface. For this reason, in a case in which distortion occurs in the image-side surface due to fixing of the lens, the distortion cannot be canceled in view of the influence of distortion of the object-side surface on the optical performance, to directly lead to degradation of imaging performance. Thus, the holding structure according to the present invention is effective.

In addition, due to asymmetry of distortion of the optical surfaces of the second lens 602 and the third lens 603, astigmatism in the sagittal direction and the meridional direction is increased. To cope with this, the first unit barrel 604 is fixed with the phase thereof being aligned to a rotation position where astigmatism of the entire optical system in the sagittal direction and the meridional direction is minimized, with the use of the above-described rotation adjustment mechanism for the first unit barrel 604. Thus, adjustment to minimize astigmatism can be achieved.

At that time, the second lens 602 is fixed to the holding barrel 303 by a weak force of the elastic member 304 in the same manner as in the first embodiment, though not shown in FIG. 6. Thus, even in a case in which vibration or the like is applied to the entire lens, the anti-rotation member 305 prevents the second lens 602 from rotating about the optical axis. Therefore, with no change in the state of the above-described lens adjustment, a highly reliable lens having stable optical performance can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-075692, filed May 1, 2023, which is hereby incorporated by reference herein in its entirety.

What is claimed is:

1. A lens apparatus comprising:
an optical member;
a holding barrel holding the optical member; and
a rotation restriction member fixed to the optical member,
wherein the rotation restriction member is configured to come into abutment against the holding barrel along a direction of rotation of the optical member about an optical axis, to restrict the rotation of the optical member about the optical axis, relative to the holding barrel, and lacks contact with the holding barrel along an optical-axis direction and a radial direction of the optical member.

2. The lens apparatus according to claim 1, wherein the rotation restriction member is fixed so as to radially protrude from an outer peripheral surface of the optical member.

3. The lens apparatus according to claim 1, wherein the rotation restriction member is fitted into a notched part provided in a part along a circumferential direction of the holding barrel.

4. The lens apparatus according to claim 1,
wherein the optical member is a lens,
wherein the lens apparatus further comprises:
a biasing barrel sandwiching the lens between the biasing barrel and the holding barrel; and
a biasing member configured to bias the biasing barrel toward the holding barrel,
wherein the holding barrel includes:
an optical axis direction receiving part configured to position the lens along the optical-axis direction; and
two orthogonal direction receiving parts configured to position the lens along an orthogonal direction orthogonal to the optical axis,
wherein, when the biasing member biases the biasing barrel, the lens is pressed against the optical axis direction receiving part and the orthogonal direction receiving parts, to be held while being positioned with respect to the holding barrel along the optical-axis direction and the orthogonal direction, and
wherein the lens apparatus further comprises a travel-amount limiting part configured to limit an amount of relative travel of the biasing barrel and the holding barrel along the optical-axis direction and the orthogonal direction while the lens is positioned and held.

5. The lens apparatus according to claim 4, wherein the holding barrel includes a guide part arranged such that the lens has some play in a plane perpendicular to the optical axis while the lens is in abutment against the optical axis direction receiving part and the orthogonal direction receiving parts.

6. The lens apparatus according to claim 5,
wherein the orthogonal direction receiving parts each have an arc shape of which radius is a radius of the lens,
wherein the guide part has an arc shape centered at the optical axis of the lens being in abutment against the optical axis direction receiving part and the orthogonal direction receiving parts, and
wherein the arc shape of the guide part has a radius larger than the radius of the lens.

7. The lens apparatus according to claim 4, wherein the travel-amount limiting part is a bayonet mechanism formed between the holding barrel and the biasing barrel.

8. The lens apparatus according to claim 4, wherein the biasing member includes at least two coil springs.

9. The lens apparatus according to claim 8, wherein a resultant force of biasing forces of the at least two coil springs acting on the lens acts on an area corresponding to a half or smaller of a distance from a center of gravity to an outer edge of the lens.

10. The lens apparatus according to claim 4,
wherein the biasing member includes two coil springs,
wherein the two coil springs are placed at positions opposite to each other across a center of gravity of the lens, and
wherein one end of each of the two coil springs is engaged with the holding barrel, and another end of each of the two coil springs is engaged with the biasing barrel, so that the two coil springs are placed obliquely with respect to a plane perpendicular to the optical axis.

11. The lens apparatus according to claim 8, wherein each of the two coil springs is placed at an angle of 30 degrees or larger and 60 degrees or smaller with respect to the plane perpendicular to the optical axis.

12. The lens apparatus according to claim 8, wherein each of the two coil springs is placed at an angle of 40 degrees or larger and 50 degrees or smaller with respect to the plane perpendicular to the optical axis.

13. The lens apparatus according to claim 8, wherein the two coil springs are placed in parallel with each other.

14. The lens apparatus according to claim 1,
wherein the optical member is a mirror, and
wherein the lens apparatus further comprises:
a biasing barrel sandwiching the mirror between the biasing barrel and the holding barrel; and
a biasing member configured to bias the biasing barrel toward the holding barrel.

15. An image pickup apparatus comprising:
a lens apparatus comprising:
an optical member;
a holding barrel holding the optical member; and
a rotation restriction member fixed to the optical member,
wherein the rotation restriction member is configured to come into abutment against the holding barrel along a direction of rotation of the optical member about an optical axis, to restrict the rotation of the optical member about the optical axis, relative to the holding barrel, and lacks contact with the holding barrel along an optical-axis direction and a radial direction of the optical member; and
an image pickup element configured to pick up an image formed by the lens apparatus.
